(19) United States
(12) Patent Application Publication
(10) Pub. No.: US 2006/0185188 A1
(43) Pub. Date: Aug. 24, 2006

(54) Moisture retaining wrapper

(76) Inventor: Joyce Ann Beaman, Lutherville, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 10/988,017

(22) Filed: Feb. 2, 2005

(51) Int. Cl. F26B 3/00

(52) U.S. Cl. 34/331

(57) ABSTRACT

A moisture-retaining cover comprising at least two layers, preferably an outer layer, made up of a soft cotton or fleece material and an inner layer made up of latex or other plastic product material and are conventionally sewed/stitched together in the desired shape as per the requirement.

### FIELD OF THE INVENTION

The present invention relates to the moisture-management garment and more particularly to the moisture-retaining cover in the form of socks, gloves, knee wraps, elbow sleeves, ankle wraps or for any other conceivable dry area of the body, so as to soften and provide treatment for rough, dry and cracked skin.

### DESCRIPTION OF THE RELATED ART

The problem of dry feet, hands, elbows, knees etc. has plagued mankind since the dawn of history. Many attempts have been made to keep feet, hands, elbows, knees etc moist in order to avoid rough, dry and cracked skin for hands, feet, etc. The problem, however, is not as simple as just keeping the feet, hands, elbows, knees etc. always moist. This can be temporarily achieved by pedicures and manicures, however they are time consuming and costly.

Conventional lotions only attempt to replace natural moisture with artificial moisture. The problem is that they come off when you wash or touch something. Additionally, in order for any moisturizers to actually improve a dry skin condition it needs to get below your second major layer of skin. In reality the only moisture that is going to reach this level is your skin's own natural moisture. Additionally, when you apply artificial moisture to the skin's surface you may be sending the wrong message—that your skin is being adequately moisturized, when in fact it is actually dehydrated the natural moisture. This often results in reducing production of natural moisture, which is vital to abate a dry skin condition.

Numerous patents have been obtained on waterproof socks/boot liner, waterproof breathable socks, socks with moisture-free environment for the foot, oversock, foot and leg warmer, double socks, inner socks and lining within gloves. But none of them taken either singularly or in combination is seen to describe the instant invention that is moisture-retaining cover, as claimed solving the aforementioned problems as desired.

### SUMMARY OF THE INVENTION

This invention concerns a moisture-retaining cover or the like, with at least two layers, preferably an outer layer, made up of a soft cotton or fleece material and an inner layer made up of latex or other plastic product material. Both the outer layer and the inner layer are, in an perferred embodiment, conventionally sewed and or stitched together in the desired shape as per the requirement. The latex or other plastic product material resists the moisture produced by the body to escape out and hence moisture is retained inside the cover itself. The moisture-retaining cover can be manufactured in various shapes and of different sizes, as well as the colors would vary. The moisture-retaining cover would be washable and reusable again with high degree of moisture-management.

Accordingly, it is a principal object of the invention to keep the hands, feet, elbows, knee etc. moist. (protection against dryness).

It is another object of the invention to create a moisture-retaining cover that is hand-washable for multiple uses.

It is yet an object of the invention to provide a moisture-retaining cover to soften and provide treatment for rough, dry and cracked skin for hands, feet, etc.

It is yet another object of the invention to provide a moisture-retaining cover, which can be simply slipped in the hands, feet, elbows, knee etc.

It is yet a further object of the invention to provide a moisture-retaining cover that is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1, is the cross-sectional of a moisture-retaining cover according to the present invention in the form of a sock

FIG. 2 is a piece of said cover of which the various articles are made.

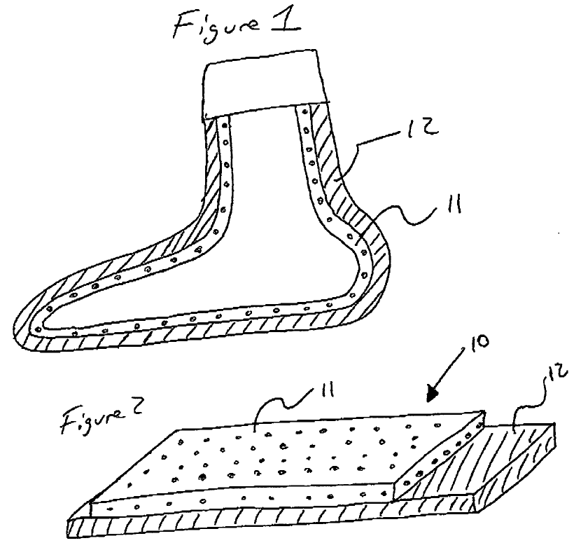

### DETAILED DESCRIPTION OF THE PREFERRED EMBODIMENTS

The present invention is drawn to a moisture-retaining cover (10) that is used to keep the hands, feet, elbows, knee etc. moist. (protection against dryness). The moisture-retaining cover (10) is constructed of at least two layers preferably an outer layer (12), made up of a soft cotton or fleece material and an inner layer (11) made up of latex or other plastic product material, in a preferred embodiment. Obviously, other materials meeting the requirements of the preferred material could be employed. Both the said outer layer and the inner layer are conventionally sewed/stitched together in the desired shape as per the requirement.

The inner layer (11) of the moisture-retaining cover (10) may be constructed from any suitable material possessing characteristics using any suitable method including, e.g., common methods of producing surgical gloves. Such materials include latex, rubber, vinyl, synthetic nitrile, or a waterproof, breathable material such as polytetrafluoroethylene commonly known by the trade name GORE-TEX.

Another preferred embodiment of the invention is that the bottom outer part of the garment is layered with non-slip grip (rubber is conceived however anything that can be used in furtherance of this invention can be used), particularly for socks, that allow for traction when walking. However, it should not be used to go outside, it is simply for inside wearing and sleeping. The advantage of the product is that it is safe, fast and easy to use. The product is designed to soften and provide treatment for rough, dry and cracked skin for hands, feet, etc.

Here it may be noted that the product redistributes natural moisture, preventing dry skin. However the product will work best when the area is cleaned.

It is to be understood that the present invention is not limited to the embodiments described above, but encompasses any and all embodiments within the scope of the following claims.

1. A moisture-retaining cover comprising at least two layers, preferably an outer layer, made up of a soft cotton or fleece material and an inner layer made up of latex or other plastic product material, in the form of socks, gloves, knee wraps, elbow sleeves, ankle wraps or the like.

2. A moisture-retaining cover as claimed claim 1, wherein both the said outer layer and the said inner layer are conventionally sewed/stitched together in the desired shape as per the requirement.

3. A moisture-retaining cover as claimed claim 1, wherein the said latex or other plastic product material includes rubber, vinyl, synthetic nitrile, or a waterproof, breathable material such as polytetrafluoroethylene commonly used in surgical gloves.

4. A moisture-retaining cover as claimed claim 1, wherein the said latex or other plastic product material resists the moisture produced by the body to escape out and hence moisture is retained inside the cover.

5. A moisture-retaining cover as claimed claim 1, wherein it is hand-washable for multiple uses.

6. A moisture-retaining cover as claimed claim 1, wherein it is inexpensive, dependable and fully effective in accomplishing its intended purposes.

7. A moisture-retaining cover as claimed claim 1, wherein the bottom outer part of the garment made of the same is layered with non-slip grip particularly for socks, that allow for traction when walking.
